(19) United States
(12) Patent Application Publication
(10) Pub. No.: US 2024/0369672 A1
(43) Pub. Date: Nov. 7, 2024

(54) STEP SIZE AND STEP HEADING CORRECTION FOR POSITIONING IN WIRELESS NETWORK

(71) Applicant: Samsung Electronics Co., Ltd., Suwon-si (KR)

(72) Inventors: Rebal Jurdi, Allen, TX (US); Neha Dawar, McKinney, TX (US); Yuming Zhu, Plano, TX (US); Jianzhong Zhang, Plano, TX (US); Johnny Kyu-Hui Han, Seoul (KR)

(21) Appl. No.: 18/639,863

(22) Filed: Apr. 18, 2024

Related U.S. Application Data
(60) Provisional application No. 63/464,031, filed on May 4, 2023.

(51) Int. Cl. G01S 5/02

(52) U.S. Cl. CPC G01S 5/02585; G01S 5/021

(57) ABSTRACT

A method for estimating a position of a moving object comprises: storing one or more reference position estimates for the moving object in a first buffer; storing step information in a second buffer, the step information including one or more step sizes and one or more step headings; receiving a motion event signal indicating the moving object moves continuously with a bounded direction; correcting the step information based on the one or more reference position estimates in response to receiving the motion event signal; and estimating the position of the moving object using the corrected step information.

### CROSS-REFERENCE TO RELATED APPLICATIONS

This application claims the benefit of priority from U.S. Provisional Application No. 63/464,031, entitled “METHODS FOR STEP SIZE AND HEADING CORRECTION FOR PEDESTRIAN-DEAD-RECKONING-BASED POSITIONING,” filed May 4, 2023, which is incorporated herein by reference in its entirety.

### TECHNICAL FIELD

This disclosure relates generally to wireless communication systems, and more particularly to, for example, but not limited to, positioning in wireless communication systems.

### BACKGROUND

Over the past decade, indoor positioning has surged in popularity, driven by the increasing number of personal wireless devices and the expansion of wireless infrastructure. Various indoor positioning applications have emerged, spanning smart homes, buildings, surveillance, disaster management, industry, and healthcare, all demanding broad availability and precise accuracy. However, traditional positioning methods often suffer from limitations such as inaccuracy, impracticality, and scarcity. Ultra-wideband (UWB) technology has been adopted for indoor positioning. While UWB offers great accuracy, it lacks widespread adoption of UWB devices for use as ranging anchor points, unlike Wi-Fi, which is ubiquitous in commercial and residential environments. With Wi-Fi access points and stations pervading most spaces, indoor positioning using Wi-Fi has emerged as a preferred solution.

The description set forth in the background section should not be assumed to be prior art merely because it is set forth in the background section. The background section may describe aspects or embodiments of the present disclosure.

### SUMMARY

An aspect of the present disclosure provides a method for estimating a position of a moving object. The method comprise: storing one or more reference position estimates for the moving object in a first buffer; storing step information in a second buffer, the step information including one or more step sizes and one or more step headings; receiving a motion event signal indicating the moving object moves continuously with a bounded direction; correcting the step information based on the one or more reference position estimates in response to receiving the motion event signal; and estimating the position of the moving object using the corrected step information.

In some embodiments, the correcting the step information comprises: determining a first direction based on one or more step headings stored in the second buffer; determining a second direction based on a slope of a line derived from at least two reference position estimates stored in the first buffer; determining an offset using the first direction and the second direction; and correcting one or more step headings using the offset.

In some embodiments, the correcting the step information comprises: determining a displacement based on a line derived from at least two reference position estimates stored in the first buffer; determining a scale factor based on the displacement and a sum of one or more step sizes stored in the second buffer; and correcting one or more step sizes using the scale factor.

In some embodiments, the method further comprises storing one or more ranging measurements provided from a ranging device in a third buffer, the one or more ranging measurements including distances between the moving object and a set of anchor points.

In some embodiments, the correcting the step information comprises: estimating positions of the moving object by filtering one or more ranging measurements stored in the third buffer using a damping filter; determining a third direction based on one or more step headings stored in the second buffer; determining a fourth direction based on a slope of a line derived from at least two estimated positions; determining an offset using the third direction and the fourth direction; and correcting one or more step headings using the offset.

In some embodiments, the method further comprises storing the estimated positions in a fourth buffer.

In some embodiments, the damping filter is initialized at a time which is prior to receiving the motion event signal.

In some embodiments, the motion event signal is received between the two most recent reference position estimates.

In some embodiments, the step information stored in the second buffer and the one or more ranging measurements stored in the third buffer are generated between two most recent reference position estimates.

In some embodiments, the method further comprises storing one or more sensor readings indicating orientation of the moving object in a fifth buffer. The correcting the step information comprises: determining a first orientation based on one or more sensor readings in the fifth buffer; determining a second orientation based on a slope of a line derived from at least two reference position estimates stored in the first buffer; determining an offset using the first orientation and the second orientation; and determining a corrected orientation using the offset.

An aspect of the present disclosure provides a device for estimating a position of the device. The device comprises a sensor configured to generate step information, the step information including one or more step sizes and one or more step headings, and a processor coupled to the sensor, the processor configured to cause: storing one or more reference position estimates for the device in a first buffer; storing the step information generated from the sensor in a second buffer; receiving a motion event signal indicating the device moves continuously with a bounded direction from the sensor; correcting the step information based on the one or more reference position estimates in response to receiving the motion event signal; and estimating the position of the device using the corrected step information.

In some embodiments, the correcting the step information comprises: determining a first direction based on one or more step headings stored in the second buffer; determining a second direction based on a slope of a line derived from at least two reference position estimates stored in the first buffer; determining an offset using the first direction and the second direction; and correcting one or more step headings using the offset.

In some embodiments, the correcting the step information comprises: determining a displacement based on a line derived from at least two reference position estimates stored in the first buffer; determining a scale factor based on the displacement and a sum of one or more step sizes stored in the second buffer; and correcting one or more step sizes using the scale factor.

In some embodiments, the device further comprises a ranging device configured to generate one or more ranging measurements including distances between the device and a set of anchor points, and the processor is further configured to cause storing the one or more ranging measurements generated from the ranging device in a third buffer.

In some embodiments, the correcting the step information comprises: estimating positions of the device by filtering one or more ranging measurements stored in the third buffer using a damping filter; determining a third direction based on one or more step headings stored in the second buffer; determining a fourth direction based on a slope of a line derived from at least two estimated positions; determining an offset using the third direction and the fourth direction; and correcting one or more step headings using the offset.

In some embodiments, the correcting the step information further comprises storing the estimated positions in fourth buffer.

In some embodiments, the damping filter is initialized at a time which is prior to receiving the motion event signal.

In some embodiments, the motion event signal is received between the two most recent reference position estimates.

In some embodiments, the step information stored in the second buffer and the one or more ranging measurements stored in the third buffer are generated between two most recent reference position estimates.

In some embodiments, the processor is further configured to cause storing one or more sensor readings indicating orientation of the moving object in a fifth buffer. The correcting the step information comprises: determining a first orientation based on one or more sensor readings in the fifth buffer; determining a second orientation based on a slope of a line derived from at least two reference position estimates stored in the first buffer; determining an offset using the first orientation and the second orientation; and determining a corrected orientation using the offset.

### BRIEF DESCRIPTION OF THE DRAWINGS

FIG. 1 shows an example of a wireless network in accordance with an embodiment.

FIG. 2A shows an example of AP in accordance with an embodiment.

FIG. 2B shows an example of STA in accordance with an embodiment.

FIG. 3 shows an example of a sensing device in accordance with an embodiment.

FIG. 4 shows an example of FTM parameters element format in accordance with an embodiment.

FIG. 5 shows an example measurement phase of an FTM session in accordance with an embodiment.

FIG. 6 shows an example trilateration method in accordance with an embodiment.

FIG. 7A shows an example step and heading (SH) motion model in accordance with an embodiment.

FIG. 7B shows an example random walk (RW) motion model in accordance with an embodiment.

FIG. 8A shows an example positioning device in accordance with an embodiment.

FIG. 8B shows an example correction unit (CU) in accordance with an embodiment.

FIG. 9 shows an example flowchart of a step heading correction process in accordance with an embodiment.

FIG. 10 shows an example flowchart of a step size correction process in accordance with an embodiment.

FIG. 11 shows an example state diagram for a state machine in the correction unit (CU) in accordance with an embodiment.

FIG. 12 shows another example correction unit (CU) in accordance with an embodiment.

FIG. 13 shows an example for damping filter initialization in accordance with an embodiment.

FIG. 14 shows an example of damping filter maintenance in accordance with an embodiment.

FIG. 15 shows an example of implied step heading and orientation offset in accordance with an embodiment.

FIG. 16 shows an example flowchart of a step heading correction process in accordance with an embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in various ways, all without departing from the scope of the present disclosure. Accordingly, the drawings and description are to be regarded as illustrative in nature and not restrictive. Like reference numerals designate like elements.

The following description is directed to certain implementations for the purpose of describing the innovative aspects of this disclosure. However, a person having ordinary skill in the art will readily recognize that the teachings herein can be applied in a multitude of different ways. The examples in this disclosure are based on WLAN communication according to the Institute of Electrical and Electronics Engineers (IEEE) 802.11 standard, including IEEE 802.11be standard and any future amendments to the IEEE 802.11 standard. However, the described embodiments may be implemented in any device, system or network that is capable of transmitting and receiving radio frequency (RF) signals according to the IEEE 802.11 standard, the Bluetooth standard, Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), 5G NR (New Radio), AMPS, or other known signals that are used to communicate within a wireless, cellular or internet of things (IoT) network, such as a system utilizing 3G, 4G, 5G, 6G, or further implementations thereof, technology.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Multi-link operation (MLO) is a key feature that is currently being developed by the standards body for next generation extremely high throughput (EHT) Wi-Fi systems in IEEE 802.11be. The Wi-Fi devices that support MLO are referred to as multi-link devices (MLD). With MLO, it is possible for a non-AP MLD to discover, authenticate, associate, and set up multiple links with an AP MLD. Channel access and frame exchange is possible on each link between the AP MLD and non-AP MLD.

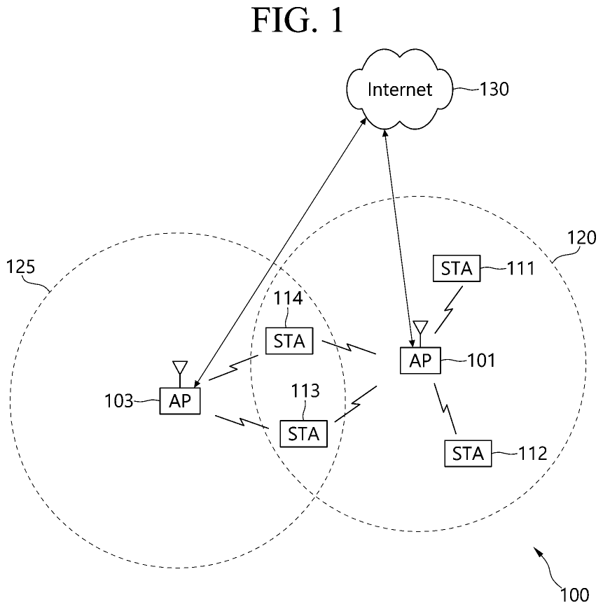

FIG. 1 shows an example of a wireless network 100 in accordance with an embodiment. The embodiment of the wireless network 100 shown in FIG. 1 is for illustrative purposes only. Other embodiments of the wireless network 100 could be used without departing from the scope of this disclosure.

As shown in FIG. 1, the wireless network 100 may include a plurality of wireless communication devices. Each wireless communication device may include one or more stations (STAs). The STA may be a logical entity that is a singly addressable instance of a medium access control (MAC) layer and a physical (PHY) layer interface to the wireless medium. The STA may be classified into an access point (AP) STA and a non-access point (non-AP) STA. The AP STA may be an entity that provides access to the distribution system service via the wireless medium for associated STAs. The non-AP STA may be a STA that is not contained within an AP-STA. For the sake of simplicity of description, an AP STA may be referred to as an AP and a non-AP STA may be referred to as a STA. In the example of FIG. 1, APs 101 and 103 are wireless communication devices, each of which may include one or more AP STAs. In such embodiments, APs 101 and 103 may be AP multi-link device (MLD). Similarly, STAs 111-114 are wireless communication devices, each of which may include one or more non-AP STAs. In such embodiments, STAs 111-114 may be non-AP MLD.

The APs 101 and 103 communicate with at least one network 130, such as the Internet, a proprietary Internet Protocol (IP) network, or other data network. The AP 101 provides wireless access to the network 130 for a plurality of stations (STAs) 111-114 with a coverage are 120 of the AP 101. The APs 101 and 103 may communicate with each other and with the STAs using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

In FIG. 1, dotted lines show the approximate extents of the coverage area 120 and 125 of APs 101 and 103, which are shown as approximately circular for the purposes of illustration and explanation. It should be clearly understood that coverage areas associated with APs, such as the coverage areas 120 and 125, may have other shapes, including irregular shapes, depending on the configuration of the APs.

As described in more detail below, one or more of the APs may include circuitry and/or programming for management of MU-MIMO and OFDMA channel sounding in WLANs. Although FIG. 1 shows one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101 and 103 could communicate directly with the network 130 and provides STAs with direct wireless broadband access to the network 130. Further, the APs 101 and/or 103 could provide access to other or additional external networks, such as external telephone networks or other types of data networks.

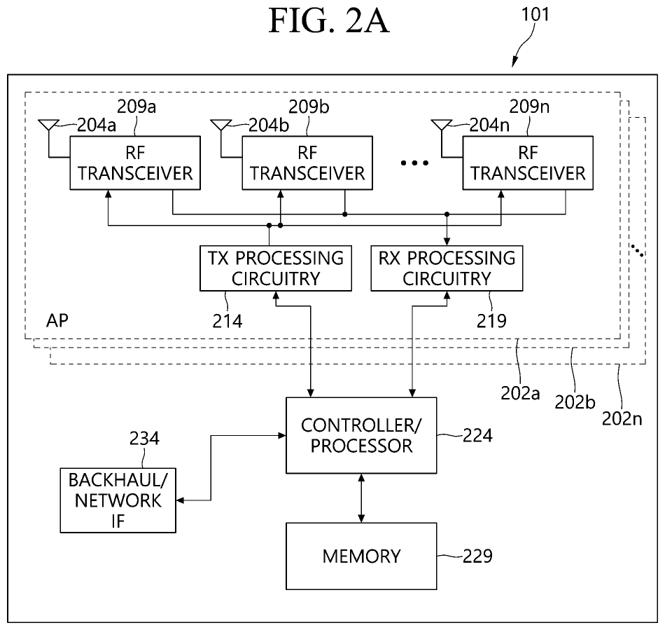

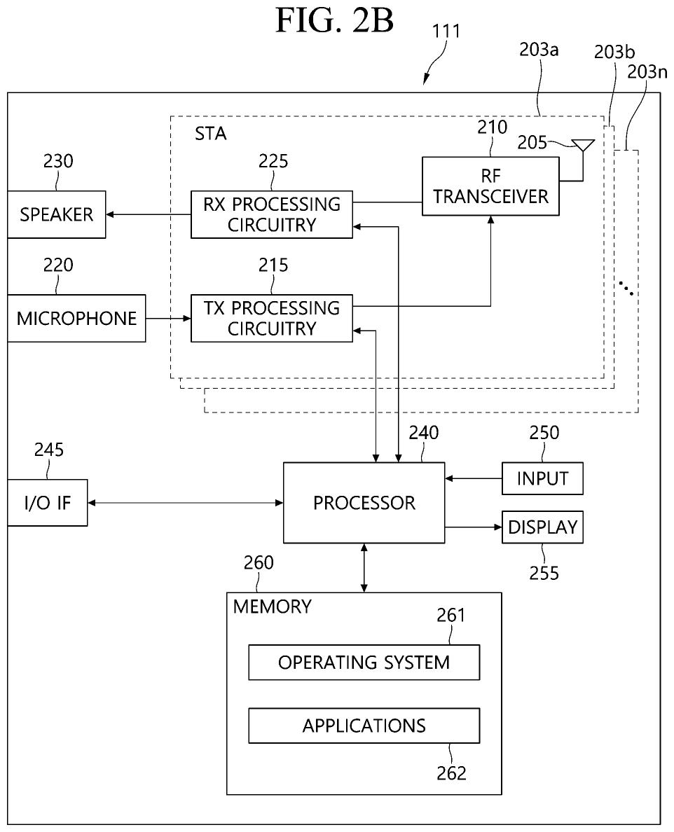

FIG. 2A shows an example of AP 101 in accordance with an embodiment. The embodiment of the AP 101 shown in FIG. 2A is for illustrative purposes, and the AP 103 of FIG. 1 could have the same or similar configuration. However, APs come in a wide range of configurations, and FIG. 2A does not limit the scope of this disclosure to any particular implementation of an AP.

As shown in FIG. 2A, the AP 101 may include multiple antennas 204a-204n, multiple radio frequency (RF) transceivers 209a-209n, transmit (TX) processing circuitry 214, and receive (RX) processing circuitry 219. The AP 101 also may include a controller/processor 224, a memory 229, and a backhaul or network interface 234. The RF transceivers 209a-209n receive, from the antennas 204a-204n, incoming RF signals, such as signals transmitted by STAs in the network 100. The RF transceivers 209a-209n down-convert the incoming RF signals to generate intermediate (IF) or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

The TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of uplink signals and the transmission of downlink signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including a combination of DL MU-MIMO and OFDMA in the same transmit opportunity. In some embodiments, the controller/processor 224 may include at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 may include any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for management of channel sounding procedures in WLANs. Although FIG. 2A illustrates one example of AP 101, various changes may be made to FIG. 2A. For example, the AP 101 could include any number of each component shown in FIG. 2A. As a particular example, an AP could include a number of interfaces 234, and the controller/processor 224 could support routing functions to route data between different network addresses. As another example, while shown as including a single instance of TX processing circuitry 214 and a single instance of RX processing circuitry 219, the AP 101 could include multiple instances of each (such as one per RF transceiver). Alternatively, only one antenna and RF transceiver path may be included, such as in legacy APs. Also, various components in FIG. 2A could be combined, further subdivided, or omitted and additional components could be added according to particular needs.

As shown in FIG. 2A, in some embodiment, the AP 101 may be an AP MLD that includes multiple APs 202a-202n. Each AP 202a-202n is affiliated with the AP MLD 101 and includes multiple antennas 204a-204n, multiple radio frequency (RF) transceivers 209a-209n, transmit (TX) processing circuitry 214, and receive (RX) processing circuitry 219. Each APs 202a-202n may independently communicate with the controller/processor 224 and other components of the AP MLD 101. FIG. 2A shows that each AP 202a-202n has separate multiple antennas, but each AP 202a-202n can share multiple antennas 204a-204n without needing separate multiple antennas. Each AP 202a-202n may represent a physical (PHY) layer and a lower media access control (MAC) layer.

FIG. 2B shows an example of STA 111 in accordance with an embodiment. The embodiment of the STA 111 shown in FIG. 2B is for illustrative purposes, and the STAs 111-114 of FIG. 1 could have the same or similar configuration. However, STAs come in a wide variety of configurations, and FIG. 2B does not limit the scope of this disclosure to any particular implementation of a STA.

As shown in FIG. 2B, the STA 111 may include antenna(s) 205, a RF transceiver 210, TX processing circuitry 215, a microphone 220, and RX processing circuitry 225. The STA 111 also may include a speaker 230, a controller/processor 240, an input/output (I/O) interface (IF) 245, a touchscreen 250, a display 255, and a memory 260. The memory 260 may include an operating system (OS) 261 and one or more applications 262.

The RF transceiver 210 receives, from the antenna(s) 205, an incoming RF signal transmitted by an AP of the network 100. The RF transceiver 210 down-converts the incoming RF signal to generate an IF or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

The TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205.

The controller/processor 240 can include one or more processors and execute the basic OS program 261 stored in the memory 260 in order to control the overall operation of the STA 111. In one such operation, the controller/processor 240 controls the reception of downlink signals and the transmission of uplink signals by the RF transceiver 210, the RX processing circuitry 225, and the TX processing circuitry 215 in accordance with well-known principles. The controller/processor 240 can also include processing circuitry configured to provide management of channel sounding procedures in WLANs. In some embodiments, the controller/processor 240 may include at least one microprocessor or microcontroller.

The controller/processor 240 is also capable of executing other processes and programs resident in the memory 260, such as operations for management of channel sounding procedures in WLANs. The controller/processor 240 can move data into or out of the memory 260 as required by an executing process. In some embodiments, the controller/processor 240 is configured to execute a plurality of applications 262, such as applications for channel sounding, including feedback computation based on a received null data packet announcement (NDPA) and null data packet (NDP) and transmitting the beamforming feedback report in response to a trigger frame (TF). The controller/processor 240 can operate the plurality of applications 262 based on the OS program 261 or in response to a signal received from an AP. The controller/processor 240 is also coupled to the I/O interface 245, which provides STA 111 with the ability to connect to other devices such as laptop computers and handheld computers. The I/O interface 245 is the communication path between these accessories and the main controller/processor 240.

The controller/processor 240 is also coupled to the input 250 (such as touchscreen) and the display 255. The operator of the STA 111 can use the input 250 to enter data into the STA 111. The display 255 may be a liquid crystal display, light emitting diode display, or other display capable of rendering text and/or at least limited graphics, such as from web sites. The memory 260 is coupled to the controller/processor 240. Part of the memory 260 could include a random access memory (RAM), and another part of the memory 260 could include a Flash memory or other read-only memory (ROM).

Although FIG. 2B shows one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the controller/processor 240 could be divided into multiple processors, such as one or more central processing units (CPUs) and one or more graphics processing units (GPUs). Also, while FIG. 2B illustrates the STA 111 configured as a mobile telephone or smartphone, STAs could be configured to operate as other types of mobile or stationary devices.

As shown in FIG. 2B, in some embodiment, the STA 111 may be a non-AP MLD that includes multiple STAs 203a-203n. Each STA 203a-203n is affiliated with the non-AP MLD 111 and includes an antenna(s) 205, a RF transceiver 210, TX processing circuitry 215, and RX processing circuitry 225. Each STAs 203a-203n may independently communicate with the controller/processor 240 and other components of the non-AP MLD 111. FIG. 2B shows that each STA 203a-203n has a separate antenna, but each STA 203a-203n can share the antenna 205 without needing separate antennas. Each STA 203a-203n may represent a physical (PHY) layer and a lower media access control (MAC) layer.

As explained, indoor positioning has grown in popularity over the last decade in parallel with the growth in the number of personal wireless devices as well as wireless infrastructure. While there are numerous use cases, such as smart phones, smart buildings, surveillance, disaster management, industry and healthcare, all of them require wide availability and good accuracy. Those positioning technologies can generally be categorized into four main groups: i) a ranging-based method, ii) a dead-reckoning-based method, iii) a fingerprinting-based method, and iv) a hybrid method.

The first category is the range-based method. Positioning is estimated through range measurements, such as measurement of distances from anchor points or reference points with known position coordinates. Examples of wireless range measurements include Wi-Fi received signal strength indicator (RSSI), Wi-Fi round-trip time (RTT), and UWB time difference of arrival (TDoA). Examples of non-wireless ranging technology include optical (laser) ranging methods.

The second category is the pedestrian dead reckoning (PDR) or sensor-based method. In this category, the positioning is estimated through accumulating incremental displacements on top of a known initial position. The displacement may be computed by continuously sampling sensors, such as an inertial measurement unit (IMU) including magnetometer, accelerometer, and gyroscope.

The third category is the fingerprinting-based method. The position of an object is looked-up in a database using position-dependent inputs. There are two phases: offline and online. In the offline phase, a database is constructed, or a model is trained from an extensive set of input-output pairs. The output is the position, and the input is a set of physical quantities corresponding to a particular location, such as magnetic signatures and wireless signal strength. In the online phase, the physical quantities of interest are measured and then used to look up the position in the database.

The fourth category is a combination of aforementioned methods which is commonly known as sensor fusion or range-and-sensor-based methods. Positioning is first estimated from sensor readings through PDR and then updated through fusion with range measurements.

Dead Reckoning is a method of estimating the position of a moving object by adding incremental displacements to its last known position. Pedestrian dead reckoning (PDR) specifically refers to scenarios where the moving object is a pedestrian walking indoors or outdoors. With the proliferation of sensors embedded in smart devices, such as smartphones, tablets, and smartwatches, the PDR has naturally evolved to complement wireless positioning technologies, which have long relied on devices providing Wi-Fi or cellular services, as well as more recent and less common technologies like UWB. An inertial measurements unit (IMU) may refer to a device that comprises various sensors with distinct functions, including the accelerometer for measuring linear acceleration, the gyroscope for measuring angular velocity, and the magnetometer for measuring the strength and direction of the magnetic field. These sensors can detect motion and enable estimation of velocity (i.e., speed and heading), thereby enhancing positioning accuracy. Methods utilizing the PDR can generally be categorized into two groups: an inertial navigation (IN) method and a step-and-heading (SH) method.

The IN method tracks the position and orientation (i.e., direction), also known as attitude or bearing, of the device in two- or three-dimensional (3D) space. To determine the instantaneous position, the IN method integrates the 3D acceleration to obtain velocity, and then integrates velocity to determine the displacement from the starting point. Similarly, in order to obtain the instantaneous orientation, the IN method integrates the angular velocity from the gyroscope to obtain changes in angles from the initial orientation. However, measurement noise and biases at the level of the accelerometer and gyroscope cause a linear growth of orientation offset over time due to rotational velocity integration, and quadratic growth of displacement error over time due to double integration of the acceleration. This often forces the IN system into a tradeoff between positioning accuracy and computational complexity. Tracking and mitigating biases in sensor reading as well as managing the statistics of measurement noise over time often require complex filters with high-dimensional state vectors.

Unlike the IN method, which continuously tracks the position of the device, the SH method updates the device position less frequently by accumulating steps taken by the user from the starting point. Every step can be represented as a vector, with a magnitude indicating the step size and an argument indicating the heading of the step. Instead of directly integrating sensor readings to compute displacement and changes in orientation, the SH method performs a series of operations toward that end. First, the SH system detects a step or a stride using various methods, such as peak detection, zero-crossing detection, or template matching. Second, upon detecting a step or stride, the SH system estimates the size of the step based on the sequence of acceleration over the duration of the step. Third, the SH system estimates the step heading using the gyroscope, magnetometer, or a combination of both. All three operations are prone to errors. The step detection may suffer from misdetection, for example, due to low peaks or false alarm caused by double peaks, among other drawbacks. Similarly, errors in underlying sensor measurements and idealized models can lead to inaccuracies in step size and heading estimation. Like the IN method, the SH method also involves a trade-off between computation complexity and positioning accuracy. However, unlike the IN method, the SH method is less susceptible to drifting, particularly when estimated trajectories are corrected with range measurements in what has been previously defined as sensor-fusion-based indoor positioning system.

A sensing device provides readings of motion-related physical quantities and signals of key motion-related events. The sensing device includes an inertial measurement unit (IMU) which contains various sensors and step detectors among other components.

The IMU may be a hardware module built in the mobile device accompanying the user that measures the device's pose and orientation as well as acceleration using sensors such as gyroscope, accelerator, and magnetometer. The gyroscope measures the three-dimensional angular velocity, the accelerometer measures three-dimensional acceleration, and the magnetometer measures the strength of the magnetic field in three dimensions. These sensors measure and report key fundamental quantities from which other kinetic quantities can be derived.

In some embodiments, in the context of inertial navigation methods for positioning, the acceleration can be integrated to obtain velocity and double-integrated to obtain displacement. The rotational velocity can be integrated to obtain a rotation angle.

In some embodiments, in the context of step and heading methods of positioning, the acceleration provides a step detector, which is also known as a pedometer, means to detect a step and measure the step size. The angular velocity and magnetic field provide means to determine the direction or heading of motion of moving object. More sophisticated step detectors can be capable of computing various motion related quantities, such as quantities related to gait which represents the user's walking patterns, as well as detecting motion-related events such as falling, stopping, and walking in a straight line.

In some embodiments, walking in a straight line may include two events: i) walking continuously and ii) maintaining the heading or the direction. Walking continuously may require a threshold number of steps per minute or non-zero speed, which can be inferred from the acceleration. Maintaining heading may require a constrained device pose, which can be inferred from the gyroscope or magnetometer. In some embodiments, the sensing device and its components can be implemented using software, hardware, or a combination of both.

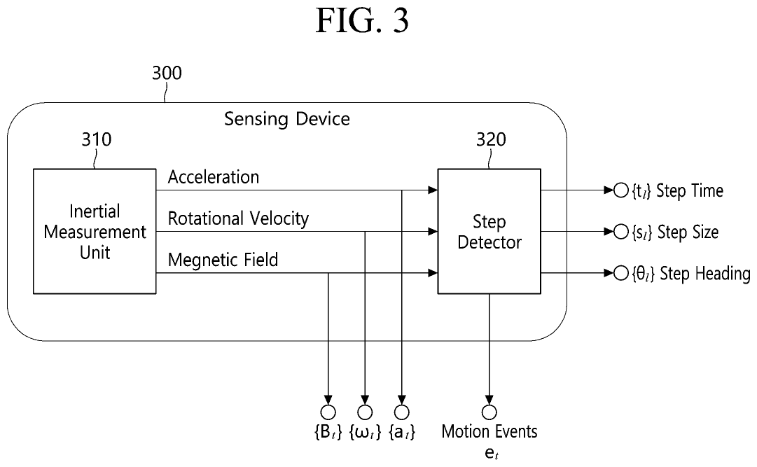

FIG. 3 shows an example of a sensing device in accordance with an embodiment. The sensing device 300 depicted in FIG. 3 is for illustration purposes and does not limit the scope of this disclosure to any particular implementations.

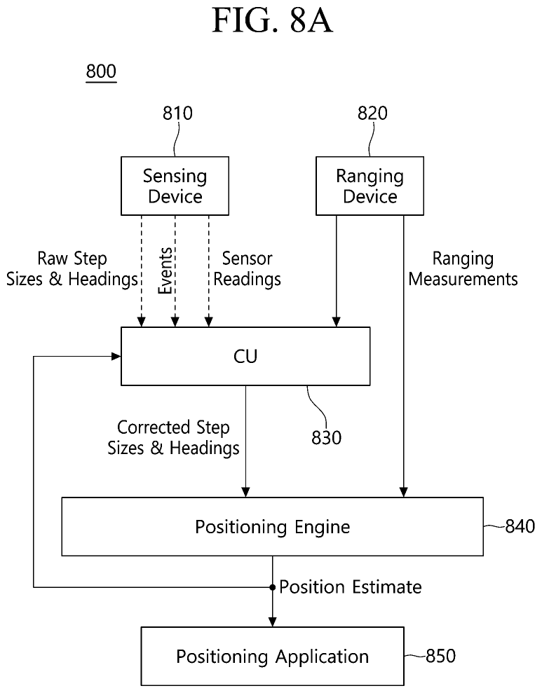

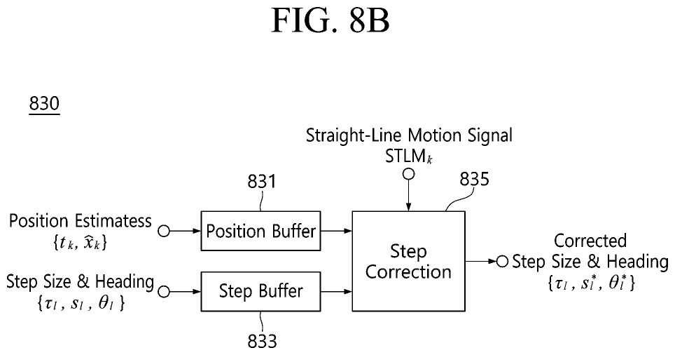

In FIG. 3, the sensing device 300 includes an inertial measurement unit (IMU) 310 and a step detector 320. The IMU 310 streams sensor readings, such as acceleration (αₜ), rotational velocity (ωₜ), and magnetic field strength (Bₜ) to the step detector 320. In some embodiments, the IMU 310 may feed the sensor readings to other device or unit, for example, a correction unit 830 depicted in FIG. 8A. The step detector 320 detects step time (tₗ) and computes step size (Sₗ) and step heading (θₗ) using the input {αₜ, ωₜ, Bₜ} and provide the detected parameters to one or more other device or units, such as a correction unit 830 depicted in FIG. 8A. In some embodiments, the step detector 320 may detect a motion event of moving object and provide it to other device or unit, for example, a correction unit 830 depicted in FIG. 8A.

In a wireless (or range-based) positioning method, target devices establish their positions by measuring distances to a set of reference points with known locations, also referred to as anchor points. Measuring distance to another device (e.g., an anchor point) involves wireless signaling between the two devices, known as ranging. The ranging process is facilitated by various wireless technologies, either explicitly through a standard ranging mechanism or implicitly through capabilities such as receive power or channel impulse response measurements.

Most range-based positioning methods suffer from various drawbacks, such as inaccuracy, impracticality, and uncommonness. UWB was designed to be ranging-native and offer a solution as a ranging-based positioning method due to its high accuracy. However, UWB devices suitable for the use as ranging anchor points are rare and uncommon compared to Wi-Fi devices, which are ubiquitous in both commercial and residential spaces. Therefore, given the pervasiveness of Wi-Fi access points and stations, Wi-Fi based round-trip time (RTT) has emerged as the strongest contender in the indoor positioning race. Furthermore, the Wi-Fi standard or IEEE 802.11 standard provides the Fine Timing Measurement (FTM) mechanism for accurate ranging.

The FTM is a wireless network management procedure defined in IEEE 802.11-2016, which was merged into IEEE 802.11-2020, enabling a station (STA) to accurately measure its distance from other STAs or access points by measuring the RTT between two devices. For instance, when a STA seeks to localize itself (referred to as the initiating STA) with respect to other STA (referred to as the responding STA), the STA schedules an FTM session during which the STAs exchanges messages and measurements. The FTM session typically comprises three phases: negotiation, measurement exchange, and termination.

In the negotiation phase, the initiating STA may negotiate key parameters with the responding STA, such as frame format, bandwidth, number of bursts, burst duration, burst period, and number of measurements per burst. The negotiation may start when the initiating STA sends an FTM request frame, which is a management frame with subtype Action, to the responding STA. The FTM request frame may be called the initial FTM request frame. This initial FTM request frame may include the negotiated parameters and their values in the frame's FTM parameters element. The responding STA may respond with an FTM frame called initial FTM frame, which approves or overwrites the parameter values proposed by the initiating STA.

In the measurement phase, one or more bursts may be involved. Each burst includes one or more fine time measurements. The duration of a burst and the number of measurements may be defined by parameters, such as burst duration and FTMs per burst. The bursts are separated by interval defined by the parameter, such as burst duration.

In the termination phase, an FTM session terminates after the last burst instance, as indicated by parameters in the FTM parameters element.

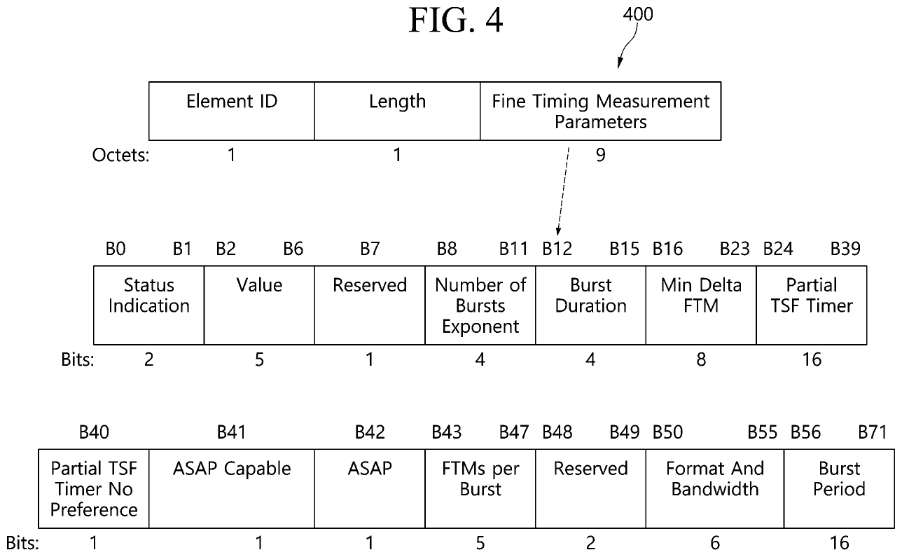

FIG. 4 shows an example of FTM parameters element format in accordance with an embodiment. The FTM parameters element may be usable in IEEE 802.11 standard.

The FTM parameters element 400 may include a number of fields that are used to advertise the requested or allocated FTM configuration from one STA to another STA. The FTM parameters element may be included in the initial FTM request frame and the initial FTM frame.

The FTM parameters element 400 may include an Element ID field, a Lenth field, and a Fine Timing Measurement Parameters field. The Element ID field includes an information to identify the FTM parameters element 400. The Length field indicates the length of the FTM parameters element 400. The Fine Time Measurement Parameters field includes a Status indication field, a Value field, a Reserved field, a Numbers of Bursts Exponent field, a Burst Duration field, a Min Delta FTM field, a Partial TST Timer field, a Partial TST Timer No Preference field, an ASAP Capable field, an ASAP field, a FTMs Per Burst field, a Reserved field, a Format And Bandwidth field, and Burst Period field.

The Status Indication field and Value field are reserved in the initial FTM request frame. The number of Burst Exponent field indicates how many burst instances are requested for the FTM session. The Burst Duration field indicates the duration of a burst instance. The Min Delta FTM field indicates the minimum time between consecutive FTM frames. The value in the Partial TSF timer field is the partial value of the responding STA's TSF at the start of the first burst instance. The Partial TSF Timer No Preference field indicates a preferred time for the start of the first burst instance in the initiating STA. The ASAP Capable field indicates that the responding STA is capable of capturing timestamps associated with an initial FTM frame and its acknowledgment and sending them in the following FTM frame. The ASAP field indicates the initiating STA's request to start the first burst instance of the FTM session with the initial FTM frame and capture timestamps corresponding to the transmission of the initial FTM frame and the receipt of its acknowledgment. The FTMS Per Burst field indicates how many successfully transmitted FTM are requested per burst instance by the initial FTM request frame or allocated by the initial FTM frame. The Format And Bandwidth field indicates the requested or allocated PPDU (physical layer protocol data unit) format and bandwidth that can be used by FTM frames in an FTM session. The Burst Period field indicates the interval between two consecutive burst instances.

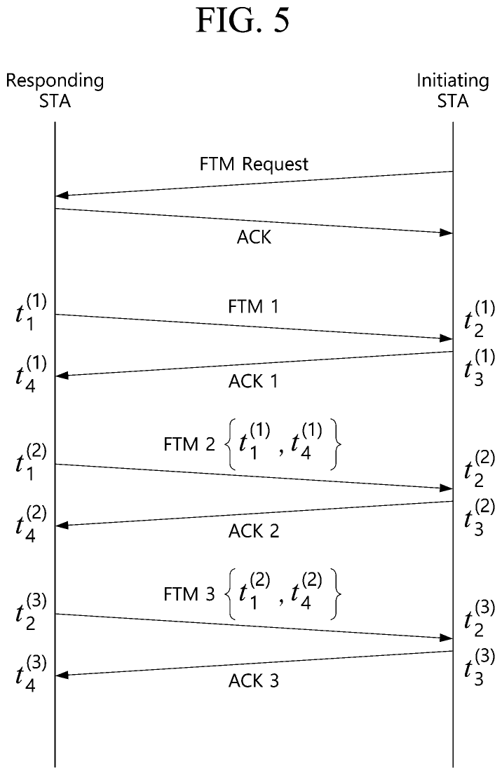

FIG. 5 shows an example measurement phase of an FTM session in accordance with an embodiment. In the example of FIG. 5, the FTM session includes one burst and three FTMs per burst.

Referring to FIG. 5, the measurement phase of the FTM session comprises following operations:
The initiating STA sends an initial FTM request frame to the responding STA. The FTM request frame triggers the start of the FTM session.
In response, the responding STA responds with an ACK.
Subsequently, the responding STA sends the first FTM frame to the initiating STA and captures the transmit time as t₁⁽¹⁾.
Upon receiving the first FTM frame (FTM 1), the initiating STA captures the receive time as t₂⁽¹⁾.
The initiating STA responds with an acknowledgement (ACK 1) and captures the transmit time as t₃⁽¹⁾.
Upon receiving the ACK, the responding STA captures the receive time as t₄⁽¹⁾.
The responding STA sends a second FTM frame (FTM 2) to the initiating STA and captures the transmit time as t₁⁽²⁾. This frame serves two purposes. Firstly, the second FTM frame (FTM 2) is a follow-up to the first FTM frame (FTM 1), transmitting the timestamps t₁⁽¹⁾ and t₄⁽¹⁾ recorded by the responding STA. Secondly, the second FTM frame starts a second measurement.
Upon receiving the second FTM frame, the initiating STA extracts the timestamps t₁⁽¹⁾ and t₄⁽¹⁾ and computes the RTT using the following equation:

$$R T T = ( {t}_{4}^{( 1 )} - {t}_{1}^{( 1 )} ) - ( {t}_{3}^{( 1 )} - {t}_{2}^{( 1 )} )$$

and captures the receive time as t₂⁽²⁾.
The initiating STA and the responding STA continue exchanging FTM frames and ACKs for as many measurements as there have been negotiated between the two.

For use in positioning and proximity applications, the RTT between the two STAs may be converted into a distance using the following equation:

$$d = \frac{R T T}{2} c$$

where d refers to the distance between the two STAs and c refers to the speed of light.

Each FTM of the burst may yield a distance sample. Therefore, multiple distance samples are obtained per burst. Given multiple FTM burst and multiple measurements per burst, these distance samples can be combined in various ways to produce a representative distance measurement. For instance, the mean distance, the median distance, or some other percentile of distance can be calculated. Furthermore, other statistics such as the standard deviation can also be utilized for positioning applications.

Trilateration is a common method to determine the position of an object in space or on a plane by measuring distances between the object and three or more reference points or anchor points with known locations (multi-lateration). The distance between the object and an anchor point can be measured directly or indirectly as a physical quantity of time that is converted to a distance. An example of the physical quantity is ‘time of flight’ of a radio signal from the anchor point to the object, or vice versa. Another example is ‘round-trip time’ between the anchor point and the object. Given there are three or more ranges, each associated with an anchor point, the position of the objected is determined by finding the intersection of three circles, each centered at one of the three anchor points.

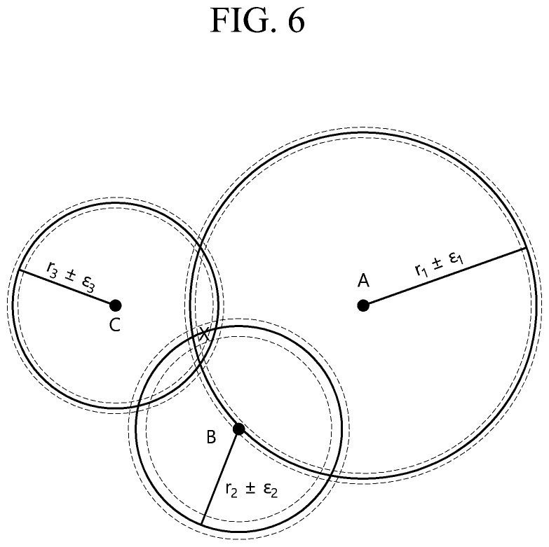

FIG. 6 shows an example trilateration method in accordance with an embodiment. The trilateration method depicted in FIG. 6 is for illustration purposes and does not limit the scope of this disclosure to any particular implementations.

Referring to FIG. 6, the trilateration estimates the position of a device (“X”) from a set of range measurements. There are three anchor points (A, B, and C). Distances from A to X, B to X, and C to X are measured as r₁±ε₁, r₂±ε₂, and r₃±ε₃, respectively. Therefore, the position of device X can be estimated by locating the intersection of three circles, each centered at one of anchor points A, B, C with the respective measured distance as its radius.

While the trilateration is an intuitive technique to derive an object's position from ranging measurements, the accuracy of positioning is highly sensitive to the ranging accuracy. For example, RTT distances obtained through FTM can suffer from low precision and low accuracy. The low accuracy can result in a steady shift in the estimated position if the distance measurements remain biased for an extended period. Furthermore, when the trilateration ignores temporal correlation across a sequence of measurements and their underlying positions, its performance pales in comparison to probabilistic approaches that estimate position over time from measurements coupled with an underlying motion model, such as Bayesian filtering, specifically, Kalman filtering.

The Bayesian framework is a mathematical tool used to estimate the state of an observed dynamic system or its probability. In this framework, the trajectory of the system is represented by a motion model, also known as a state transition model, which describes how the system evolves over time. The measurement of a state is expressed through a measurement model or an observation model, which relates the state or its probability at a given time to measurements collected at that time. With an incoming stream of measurements, the state of the system is recursively estimated in two stages, measurement by measurement. In the first stage, known as the prediction stage, a state at a point in the near future is predicted solely using the motion model. In the second stage, known as the update stage, measurements are used to correct the prediction state. The successive application of the prediction stage and update stage gives rise to what is known as the Bayesian filter. Mathematical details are provided below.

The motion model describes the evolution of the state of the system and relates the current state to the previous state. There are two ways to express the relationship: direct relationship and indirect relationship.

In the direct relationship, the new (next) state xₖ can be expressed as a random function of the previous state xₖ₋₁ and input to the system uₖ:

$${x}_{k} = f ( {u}_{k} , {x}_{k - 1} ) .$$

In the indirect relationship, a transition kernel can be provided as:

$$p ( {x}_{k} \vert {x}_{k - 1} , {u}_{k} ) .$$

The measurement model relates the current observation to the current state. Similarly, there are two ways to express this relationship: direct relationship and indirect relationship.

In the direct relationship, the observation yₖ can be expressed as a random function of the current state xₖ:

$${y}_{k} = g ( {x}_{k} )$$

In the indirect relationship, the likelihood distribution can be provided as:

$$p ( {y}_{k} \vert {x}_{k} )$$

Initially, the Bayesian filter starts with a belief b₀(x₀)=p (x₀) about the state of the system at the very beginning. At each time index k, the Bayesian filter refines the belief of state of system by applying the prediction stage followed by the update stage. The state of the system can then be estimated from the belief, as the minimum mean square error estimate (MMSE), the maximum a posteriori estimate (MAP), or other methods.

In the Prediction stage, the Bayesian filter determines ‘a priori’ belief bₖ⁻(sₖ) using the state transition model as follows:

$${b}_{\overline{k}} ( {s}_{k} ) = \int \int {b}_{k - 1} ( s ) p ( s \vert {s}_{k - 1} , {u}_{k} ) d s$$

In the updated stage, the Bayesian filter updates ‘a posteriori’ belief bₖ(sₖ) using the measurement model as follows:

$${b}_{k} ( {s}_{k} ) = {b}_{\overline{k}} ( {s}_{k} ) \cdot p ( {y}_{k} \vert {s}_{k} )$$

Once the ‘a posteriori’ belief has been determined, the state can be estimated in various way including the below example:

$$\begin{matrix}{\hat{s}}_{k}^{M A P} = {argmax}_{s} {b}_{k} ( s ) \\ {\hat{s}}_{k}^{M M S E} = \int \int {b}_{k} ( s ) d s\end{matrix}$$

When both motion model and the measurement model are linear, the Bayesian filter reduces to the well-known Kalman filter. The motion and measurement equations for a linear system, and the prediction stage and the update stage for the corresponding Kalman filter are described below.

The motion equation describes the evolution of the state of the system and relates the current state to the previous state as follows:

$${x}_{k} = {A}_{k} {x}_{k - 1} + {B}_{k} {u}_{k} + {v}_{k}$$

where xₖ is the current state, xₖ₋₁ is the last state, Aₖ is the state transition matrix, uₖ is the current input, Bₖ is the control/input matrix, and vₖ˜N(0, Qₖ) is the process noise which represents uncertainty in state.

The measurement equation relates the current observation to the current state as follows:

$${y}_{k} = {H}_{k} {x}_{k} + {w}_{k}$$

where yₖ is the latest observation, Hₖ is the observation matrix, and wₖ˜N(0, Qₖ) is the observation noise.

At each time index k, the Kalman filter estimates the state of the system by applying a prediction stage followed by an update stage. The outcome of these two steps is the state estimate \hat{x}ₖ at time index k and the covariance matrix Pₖ which are in turn used to estimate the states at later points in time.

In the prediction stage, the Kalman filter predicts the current state \hat{x}_{k|k-1} (a priori estimate) from the most recent state estimate \hat{x}ₖ₋₁, the covariance Pₖ₋₁, and any inputs using the motion equation as follows:

$$\begin{matrix}{\hat{x}}_{k \vert k - 1} = {A}_{k} {\hat{x}}_{k - 1} + {B}_{k} {u}_{k} , \\ {P}_{k \vert k - 1} = {A}_{k} {P}_{k} {A}_{k}^{*} + {Q}_{k} ,\end{matrix}$$

In the update stage, the Kalman filter uses the latest observation to update the prediction and obtain the ‘a posteriori’ state estimate \hat{x}ₖ and its covariance Pₖ as follows:

$$\begin{matrix}{\hat{x}}_{k} = {\hat{x}}_{k \vert k - 1} + {K}_{k} ( {y}_{k} - {H}_{k} {\hat{x}}_{k \vert k - 1} ) \\ {P}_{k} = ( 1 - {K}_{k} {H}_{k} ) {P}_{k \vert k - 1}\end{matrix}$$

where Kₖ is the Kalman gain and is a function of the ‘a priori’ estimate covariance P_{k|k-1}, observation matrix Hₖ, and observation noise covariance matrix Rₖ.

The extended Kalman filter (EKF) is a work-around to handle non-linearities in the motion model or measurement model. If the motion equation or the measurement equation is not linear, the Kalman filter may not be used unless these equations are linearized. Consider the following non-linear motion equation and measurement equation:

$$\begin{matrix}{x}_{k} = {f}_{k} ( {x}_{k - 1} , {u}_{k} ) + {v}_{k} \\ {y}_{k} = {h}_{k} ( {x}_{k} ) + {w}_{k}\end{matrix}$$

where fₖ and hₖ are non-linear functions. The EKF applies the predict stage and update stage as follows:

In the prediction stage,

$$\begin{matrix}{\hat{x}}_{k \vert k - 1} = {f}_{k} ( {\hat{x}}_{k - 1} , {u}_{k} ) \\ {P}_{k \vert k - 1} = {F}_{k} {P}_{k} {F}_{k}^{*} + {Q}_{k} \\ where \\ {F}_{k} = \frac{\partial {f}_{k} ( x , u )}{\partial x} {\vert}_{x = {\hat{x}}_{k - 1} , u = {u}_{k}}\end{matrix}$$

In the update stage,

$$\begin{matrix}{\hat{x}}_{k} = {\hat{x}}_{k \vert k - 1} + {K}_{k} ( {y}_{k} - {H}_{k} {\hat{x}}_{k \vert k - 1} ) \\ {P}_{k} = ( 1 - {K}_{k} {H}_{k} ) {P}_{k \vert k - 1} \\ where \\ {F}_{k} = \frac{\partial {h}_{k} ( x )}{\partial x} {\vert}_{x = {\hat{x}}_{k - 1}}\end{matrix}$$

The state estimate \hat{x}ₖ and the covariance Pₖ are propagated to track the state of system. In the context of positioning, the state refers to the device position. In the context of Wi-Fi RTT indoor positioning, the observation refers to the RTT distance measurement.

In Wi-Fi RTT based positioning, the measurement model is typically taken to be an additive white Gaussian noise model:

$${y}_{k} = d ( {x}_{k} ) + {z}_{k}$$

where the measurement RTT distance yₖ is expressed as the true distance d(xₖ) between the device and the AP, plus a measurement noise term zₖ that is uncorrelated over time.

However, the motion model may be determined by the type of positioning solution as explained above. It is tailored according to the sensors available on the target device or their absence. In a range-based positioning method where IMU sensors are inaccessible, unavailable, or completely dismissed, the position of the target device can only be determined by measuring the distance to anchor points at known locations. This leads to free-range or random walk (RW) motion model that allows the target device to move freely in the vicinity of its last known position. In a sensor-based or sensor-fusion positioning method, the position of the device can be predicted through IMU sensors in the device. In a step and heading (SH) method, for instance, the position of the device is predicted by adding a displacement vector to its last known position. The displacement vector can be a sum of steps, composed of a size (magnitude) and heading (argument or angle), is computed from IMU sensors, such as accelerometer for step size, and magnetometer and gyroscope for step heading.

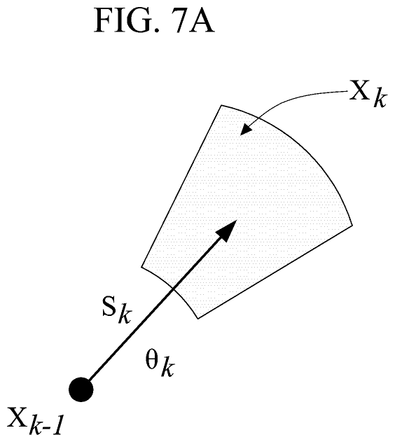

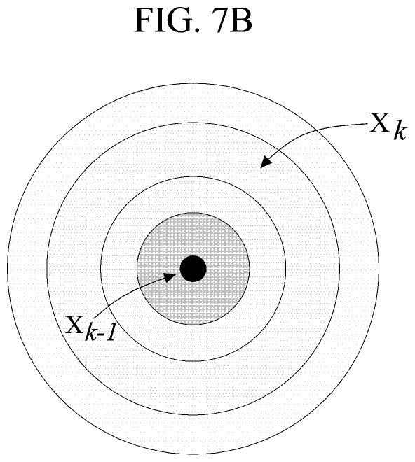

FIG. 7A shows an example step and heading (SH) motion model in accordance with an embodiment. As shown in FIG. 7A, the device position xₖ is a function of its last known position xₖ₋₁ and a displacement vector composed of the size (magnitude) Sₖ and heading (angle or argument) xₖ₋₁.

FIG. 7B shows an example random walk (RW) motion model in accordance with an embodiment. As shown in FIG. 7B, the device position xx is in the vicinity of its last known position xₖ₋₁.

The SH method is prone to estimation error, partly due to errors in the sensor readings. For example, bias in the magnetometer and gyroscope creates an offset in step heading which in turn leads to a trajectory estimate that deviates from the true trajectory by an angle equal to the orientation offset. Furthermore, the models that infer step size from acceleration may result in either overshooting or undershooting, consequently elongating or compressing the true trajectory.

The methods that correct the step size and step heading have some challenges. For instance, unstable motion, like sharp turns, can distort the step heading estimated from recent trajectory. This estimated step heading may be used as a reference to correct subsequent step headings originally obtained from sensors, such as the magnetometer and gyroscope. Furthermore, the noisy trajectory estimates, which fluctuate around the true track of motion, distorts the step heading inferred from recent position estimates, which is used as a reference to correct subsequent step headings. Similarly, the noisy trajectory distorts the estimated displacement which is used as a reference to correct step size.

The present disclosure provides a solution to correct the size and heading of the step detected by the sensor, such as a pedometer, which feeds into positioning operation based on the SH method. An aspect of the present disclosure provides a step size correction process and a step heading correction process. Another aspect of the present disclosure provides an embodiment to trigger the step size correction process and the step heading correction process when a straight-line motion event is detected. Another aspect of the present disclosure provides an embodiment to smooth noisy trajectory to be used in the step size and step heading correction process.

FIG. 8A shows an example positioning device in accordance with an embodiment. The device 800 depicted in FIG. 8A is for illustration purposes and does not limit the scope of this disclosure to any particular implementations.

In FIG. 8A, the positioning device 800 may comprise various components including a sensing device 810, a ranging device 820, a correction unit (CU) 830, a positioning engine 840, and a positioning application 850.

The sensing device 810 may include various sensors that measure the linear or rotational forces acting on the device 800 as well as the device orientation. The sensing device 300 depicted in FIG. 3 may be an example of the sensing device 810. The sensing device 810 may include various hardware sensors that measure kinematic quantities. For instance, an accelerometer measures acceleration, a gyroscope measures rotational velocity, and a magnetometer measures magnetic field which can be used to computes orientation. Additionally, the sensing device 810 may include various software sensors that generate contextual and activity-related information. For instance, a step detector or a pedometer detects individual steps and determines step size (length) and step heading, an event detector detects motion events of interest including a straight-line motion event. The straight-line motion event indicates that the user of the device 800 walks continuously while maintaining a bounded heading (direction). The sensing device 810 provides sensor data (e.g., sensor reading), such as motion event signal, step time, and step size and step heading to the CU 830. The step size and step heading are raw data which will be corrected in the CU 830.

The ranging device 820 measures distances between the device 800 and a set of anchor points. In some embodiments, the ranging device 820 may be a STA supporting Wi-Fi or IEEE 802.11 standard, acting as a FTM initiator (FTMI). Under this capacity, the STA interacts with an access point supporting Wi-Fi or IEEE 802.11 standard, acting as an FTM responder (FTMR) to compute the RTT between the two devices and convert it into distance. Alternatively, the ranging device 820 can be any wireless device that measures the receive power from a reference wireless device and converts it into a distance using a propagation mode, such as ITU (International Telecommunication Union) indoor propagation model for Wi-Fi or another empirically trained model. As such, the ranging device 820 can be prone to measurement noise in its distance measurements. The ranging device 820 provides ranging measurements to the CU 830 and the positioning engine 840.

The CU 830 corrects the step size and the step heading provided by the sensing device 810. In some embodiments, the CU 830 receives a sequence of sensor readings (e.g., acceleration, orientation derived from magnetic field, and rotational velocity), step information (e.g., step size and step heading), and motion events (e.g., a straight-line motion event) from the sensing device 810. Additionally, the CU 830 also receives a sequence of ranging measurements from the ranging device 820, as well as a sequence of position estimates from the positioning engine 840. The CU 830 corrects the step size and step heading fed from the sensing device 810 using the inputs from the sensing device 810, the ranging device 820, and the positioning engine 840. The CU 830 then provides the corrected step size and step heading to the positioning engine 840.

The CU 830 may be first framed within the context of a positioning application. While the term ‘application’ commonly refers to a software program, or ‘app’ for short, a distinction may be made between these two terms in this disclosure. In some embodiments, the term ‘app’ may specifically refer to the software manifestation or implementation of the ‘application’, which can alternatively have hardware, firmware, or mixed implementations.

The positioning engine 840 estimates device position using a combination of ranging measurement, corrected sizes and headings of the step, and sensor readings. Then, the positioning engine 840 provides position estimates to the positioning application 850 and the CU 830.

The positioning application 850 uses position estimates provided by the positioning engine 840 to carry out various tasks that may or may not involve user interaction, such as navigation, proximity detection, and asset tracking.

In some embodiments, the CU 830 may include two operations: step size correction and step heading correction. These two operations may require a recent history of positions estimates, step size/step heading, and sensor readings. In some implementations, a recent history of ranging measurements is also required for the two operations. The sequences of positions, ranges, and step information (i.e., step heading and step sizes) are stored in a position buffer, a range buffer, and step buffer, respectively. These buffers may operate as a FIFO (First In First Out) buffer and can be implemented in various ways.

In some embodiments, the FIFO buffer may include elements or samples with timestamps that fall within W (window) seconds. Therefore, the time difference between the earliest and the latest timestamps are W second or less. The window size W needs to be long enough to include multiple steps and multiple position estimates. For example, a practical range for the window size W may be 5 to 10 seconds. Adding a new sample at time t to a full FIFO buffer removes a sample added prior to time t-W. In some embodiments, the FIFO buffer may have a fixed size of N elements or samples. When adding a new sample to a full FIFO buffer, the oldest sample in the buffer is removed. The samples removed from the FIFO buffer after the insertion of new samples are referred to as ‘stale samples.’

FIG. 8B shows an example correction unit (CU) 830 in accordance with an embodiment. The operation depicted in FIG. 8B is for illustration purposes and does not limit the scope of this disclosure to any particular implementations.

In FIG. 8B, the CU 830 includes a position buffer 831, a step buffer 833, and a step correction block 835. The position buffer 831 receives and stores a sequence of position estimates {tₖ, \hat{x}ₖ} provided from the positioning engine 840. The sequence of positions is used as a reference to correct the step heading and step size. The step buffer 833 receives and stores a sequence of step information, such as time, step size and step heading {τₗ, sₗ, θₗ}, provided from the sensing device 810. In some embodiments, the CU 830 may include an orientation buffer (not shown in FIG. 8B). The orientation buffer receives and stores a sequence of recent sensor readings indicating device orientation, such as acceleration, rotational velocity, and magnetic field, provided from the sensing device 810.

Then, the position buffer 831 and the step buffer 833 feed their stored position estimates and the step information to the step correction block 835, respectively. Additionally, a motion event signal may be input to the step correction block 835 from the sensing device 810. In this example of FIG. 8B, a straight-line motion event is signaled from the sensing device 810 to the step correction block 835. In some embodiments, the orientation buffer feeds the stored sensor readings to the step correction block 835.

The step correction block 835 performs the step information correction based on the stored position estimates, the stored step information, and the motion event signal, and then feed the corrected step information {τₗ, sₗ*, θₗ*} to the positioning engine 840 and the CU 830. In some embodiments, the step correction block 835 performs step heading correction using the sensor readings provided by the orientation buffer.

In the example of FIG. 8B, while the step size correction and the step heading correction are performed jointly in the CU 830, they can be implemented separately in some embodiments.

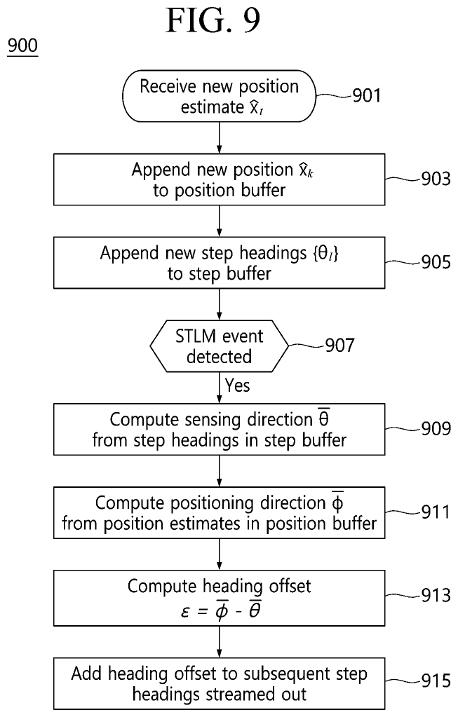

FIG. 9 shows an example flowchart of a step heading correction process in accordance with an embodiment. Although one or more operations are described or shown in particular sequential order, in other embodiments the operations may be rearranged in a different order, which may include performance of multiple operations in at least partially overlapping time periods. The flowchart depicted in FIG. 9 illustrates operations performed in the CU 830 to correct the step headings after receiving a new position estimate from the positioning engine 840. The flowchart in FIG. 9 is detailed with reference to FIGS. 8A and 8B below.

The process 900 may begin in operation 901. In operation 901, the CU 830 receives a new position estimate \hat{x}ₖ at time tₖ from the positioning engine 840. Then, the process 900 proceeds to operation 903.

In operation 903, the CU 830 enqueues or appends the new position estimate \hat{x}k and its timestamp tₖ to the position buffer 831, and dequeues or removes a stale position estimate.

In operation 905, the CU 830 enqueues or appends a new sequence of step headings {θₗ} falling between the two most recent epochs of position estimates tₖ₋₁ and tₖ to the step buffer 833, and dequeues or removes stale step headings.

In operation 907, the CU 830 determines if a straight-line motion event STLMₖ is detected or signaled between tₖ₋₁ and tₖ. If the STLMₖ is not detected or signaled, the CU 830 takes no further action until a subsequent position estimate is received. Otherwise, the process 900 proceeds to operation 909.

In operation 909, the CU 830 computes the sensing direction θ̅ by averaging the sequence of step headings {θₗ} stored in the step buffer 833. In some embodiments, the sequence of the step headings may be combined through a weighted averaging operation or through another representative value, such as median value or other percentile value. Alternatively, in some embodiments, the CU 830 maintains an orientation buffer as discussed with reference to FIG. 8B. The orientation buffer stores recent orientation sensor readings indicating device orientation, such as acceleration, rotational velocity, and magnetic field, from the sensing device 810. In this scenario, the CU 830 combines the sensor readings in the orientation buffer to compute the sensing direction.

In operation 911, the CU 830 computes the positioning direction ϕ̅ through the following operations. First, the CU 830 performs a linear regression on the sequence of position estimates {\hat{x}ₖ} in the position buffer 831 to determine the slope of the fitted line and compute its arctangent to be used as a preliminary value of ϕ̅. Then, the CU 830 computes the slope of the line passing through the first and the last position estimates in the position buffer 831. If the two slopes differ by more than 90°, 180° may be added to ϕ̅. If the two slopes differ by less than 90°, ϕ̅ remains unmodified.

In operation 913, the CU 830 computes a heading offset ε as the difference between the positioning direction and the sensing direction, for example, by the following equation:

$$ε = \overline{ϕ} - \overline{θ} .$$

In operation 915, the CU 830 corrects subsequent step headings that are streamed from the CU 830 by adding the heading offset to the sensing direction, for example, using the following equation:

$${θ}_{l}^{*} = {θ}_{l} + ε .$$

Then, the CU 830 feeds the corrected step headings to the positioning engine 840.

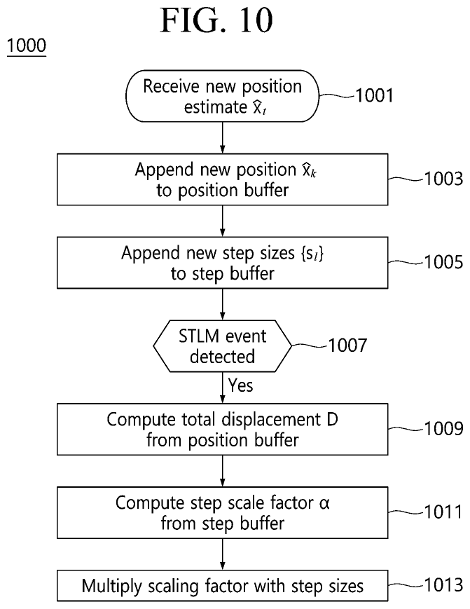

FIG. 10 shows an example flowchart of a step size correction process in accordance with an embodiment. Although one or more operations are described or shown in particular sequential order, in other embodiments the operations may be rearranged in a different order, which may include performance of multiple operations in at least partially overlapping time periods. The flowchart depicted in FIG. 10 illustrates operations performed in the CU 830 to correct the step size after receiving a new position estimate from the positioning engine 840. The flowchart in FIG. 10 is detailed with reference to FIGS. 8A and 8B below.

The process 1000 may begin in operation 1001. In operation 1001, the CU 830 receives a new position estimate \hat{x}ₖ at time tₖ. Then, the process 1000 proceeds to operation 1003.

In operation 1003, the CU 830 enqueues or appends the new position estimate \hat{x}ₖ at the timestamp tₖ to the position buffer 831, and dequeues or removes a stale position estimate.

In operation 1005, the CU 830 enqueues or appends a new sequence of step sizes {sₗ} falling between the two most recent epochs of position estimates tₖ₋₁ and tₖ to the step buffer 833, and dequeues or removes stale step sizes.

In operation 1007, the CU 830 determines if a STLMₖ is detected or signaled between tₖ₋₁ and tₖ. If the STLMₖ is not detected or signaled, the CU 830 takes no further action until a subsequent position estimate is received. Otherwise, the process 1000 proceeds to operation 1009.

In operation 1009, the CU 830 computes a total displacement D through the following operations. First, the CU 830 performs a linear regression on the sequence of position estimates {\hat{x}ₖ} in the position buffer 831. Then, the CU 830 computes the length of the segment along the fitted line between the first and last position estimates, which is used as the value of the total displacement D.

In operation 1011, the CU 830 computes the step scale factor α as a ratio of the total displacement D to the sum of step sizes stored in the step buffer 833, for example, using the following equation:

$$α = \frac{D}{{\sum }_{l} {s}_{l}}$$

In operation 1013, the CU 830 corrects subsequent step sizes that are streamed from the CU 830 by multiplying the scaling factor α with the step sizes using the following equation:

$${s}_{l}^{*} = α \cdot {s}_{l}$$

Then, the CU 830 feeds the corrected step sizes to the positioning engine 840.

In some embodiments, the CU 830 uses a state machine to correct step heading as described below. The position estimates can undergo further processing instead of being used at face value to compute an additive heading offset to correct the step heading.

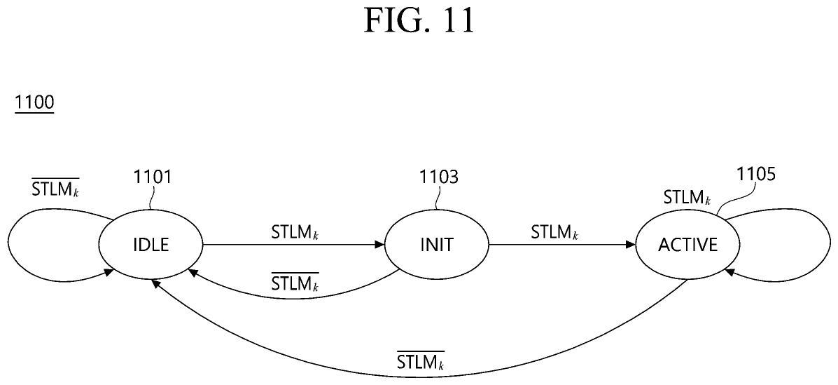

FIG. 11 shows an example state diagram for a state machine in the correction unit (CU) 830 in accordance with an embodiment. The state diagram in FIG. 11 is detailed with reference to FIGS. 8A and 8B below.

Referring to FIG. 11, the state machine includes three states: idle (IDLE) state 1101, Initialization (INIT) state 1103, and active (ACTIVE) state 1105. The transition between states may be triggered by receipt of a new position estimate from the positioning engine 840. The transition is governed by the following conditions.

In the IDLE state 1101, when a straight-line motion event STLMₖ is signaled from the sensing device 810 between the two most recent epochs of position estimates between tₖ₋₁ and tₖ, the state machine switches or changes from the IDLE state 1101 to the INIT state 1103. Otherwise, the state machine remains in the IDLE state 1101.

In the INIT state 1103, when a STLMₖ is signaled from the sensing device 810 between the two most recent epochs of position estimates between tₖ₋₁ and tₖ, the state machine switches or changes from the INIT state 1103 to the ACTIVE state 1105. Otherwise, the state machine moves back to the IDLE state 1101.

In the ACTIVE state 1105, when no STLMₖ is signaled from the sensing device 810 between the two most recent epochs of position estimates between tₖ₋₁ and tₖ, the state machine switches or changes back from the ACTIVE state 1105 to the IDLE state 1101. When a STLMₖ is signaled from the sensing device 810 between the two most recent epochs of position estimates between tₖ₋₁ and tₖ, the state machine remains in the ACTIVE state 1105.

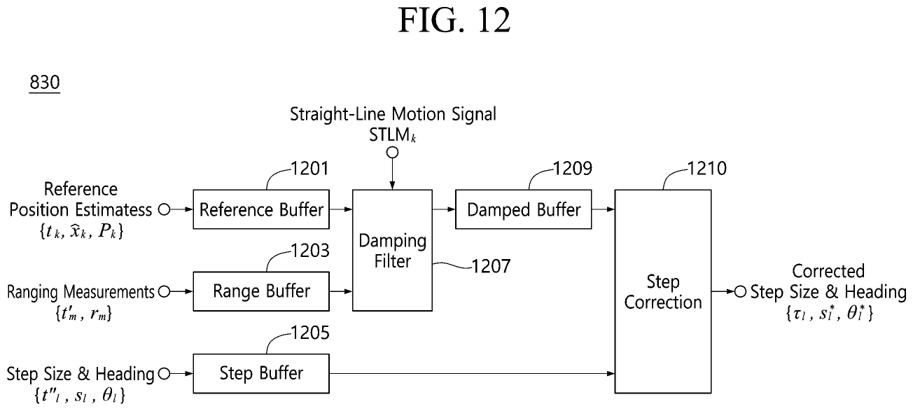

FIG. 12 shows another example correction unit (CU) 830 in accordance with an embodiment. The CU 830 depicted in FIG. 12 is for illustration purposes and does not limit the scope of this disclosure to any particular implementations.

In FIG. 12, the CU 830 includes a reference buffer 1201, a range buffer 1203, a step buffer 1205, a damping filter 1207, a damped buffer 1209, and a step correction block 1210. The reference buffer 1201 stores a sequence of reference position estimates fed back from the positioning engine 840. The reference position estimates include a new position estimate \hat{x}ₖ and its covariance matrix Pₖ and timestamp tₖ. The reference buffer 1201 is similar to the position buffer 831 depicted in FIG. 8B. The range buffer 1203 stores a sequence of ranging measurements {t′ₘ, rₘ} provided from the ranging device 820. The step buffer 1205 stores a sequence of step information, such as time, step size and step heading {tₗ, sₗ, θₗ} provided from the sensing device 810. In some embodiments, the step buffer 1205 stores a sequence of sensor reading, such as acceleration, orientation, and rotational velocity form the sensing device 810.

The damping filter 1207 receives a sequence of reference position estimates {tₖ, \hat{x}ₖ, Pₖ} from the reference buffer 1201, a sequence of ranging measurements {t′ₘ, rₘ} from the range buffer 1203, and a straight-line motion event signal from the sensing device 810. The damping filter 1207 filters the sequence of ranging measurements to obtain position estimates which are used to establish a reference trajectory for step correction when a straight-line motion signal is detected. The damped buffer 1209 stores the position estimates provided by the damping filter 1207.

The step correction block 1210 performs step information correction based on the position estimates from the damped buffer 1209 and the step information stored in the step buffer 1205, and then feed the corrected step information {τₗ, sₗ*, θₗ*} to the positioning engine 840.

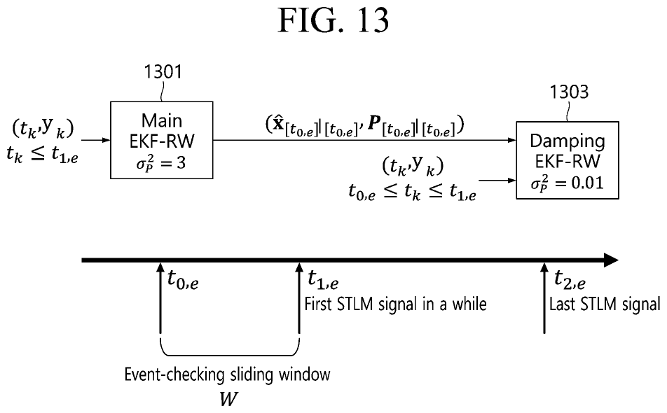

FIG. 13 shows an example for damping filter initialization in accordance with an embodiment.

In FIG. 13, a main Random Walk extended Kalman filter (EKF-RW) 1301 may be located in the positioning engine 840 depicted in FIG. 8A, and a damping EKF-RW 1303 may be an example of the damping filer 1207 depicted in FIG. 12. In the example of FIG. 13, the damping EKF-RW 1303 may have smaller variance (σₚ²=0.01) than the main EKF-RW 1301 (σₚ²=3). The main EKF-RW 1301 uses the observation (tₖ, yₖ) to obtain position estimate \hat{x}_{k|k} and its covariance P_{k|k}, which is fed into the damping EKF-RW 1303.

Referring to the bottom line of FIG. 13, the first episode of STLM event is detected at time t_{1,e} after checking the sliding window W. Moreover, the last episode of STLM event is detected at time t_{2,e}. Once the first episode of STLM event is detected at time t_{1,e}, the CU 830 backdates the STLM episode to t_{0,e}=t_{1,e}−W, and initializes the damping EKF-RW 1303 with the state (\hat{x}_{k|k}, P_{k|k}) of the Main EKF-RW 1301 at the earliest time tₖ>t_{0,e}. Subsequently, the CU 830 runs the damping EKF-RW 1303 through all past observation (tₖ, yₖ) where t_{0,e}≤tₖ≤t_{1,e}.

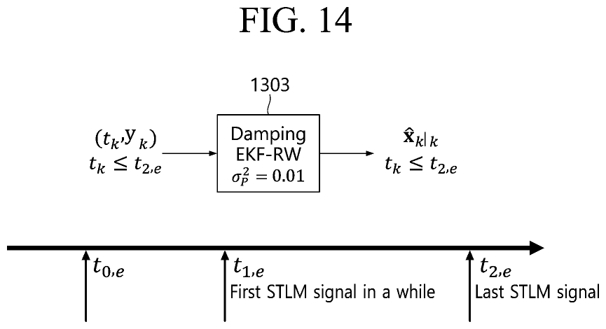

FIG. 14 shows an example of damping filter maintenance in accordance with an embodiment. Referring to FIG. 14, the CU 830 runs the damping EKF-RW 1303 on every observation (tₖ, yₖ) upon arrival until the last STLM event is detected at time t_{2,e}.

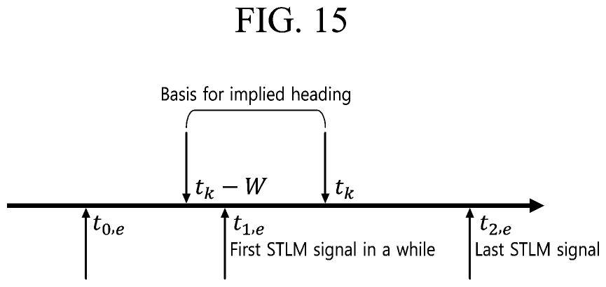

FIG. 15 shows an example of implied step heading and orientation offset in accordance with an embodiment.

Referring to FIG. 15, upon receiving observation yₖ at tₖ, the step correction block 1210 of the CU 830 computes the mean orientation ϕ̅ₖ by averaging the orientation {ϕ_{τ}} over the interval [tₖ−W, tₖ]. The orientation {ϕ_{τ}} may be the step heading stored in the step buffer 1205. In some embodiments, the mean orientation ϕ̅ₖ may be obtained from a sequence of sensor readings indicating device orientation, such as acceleration, rotational velocity, and magnetic field, stored in the orientation buffer. Then, the CU 830 computes the implied heading θ̅ₖ as the slope of straight line best fitting the position estimates {(\hat{x}_{l|l})} obtained in the interval [tₖ−W, tₖ]. Subsequently, the CU 830 compute the mean orientation offset as ε̅=θ̅ₖ-ϕ̅ₖ.

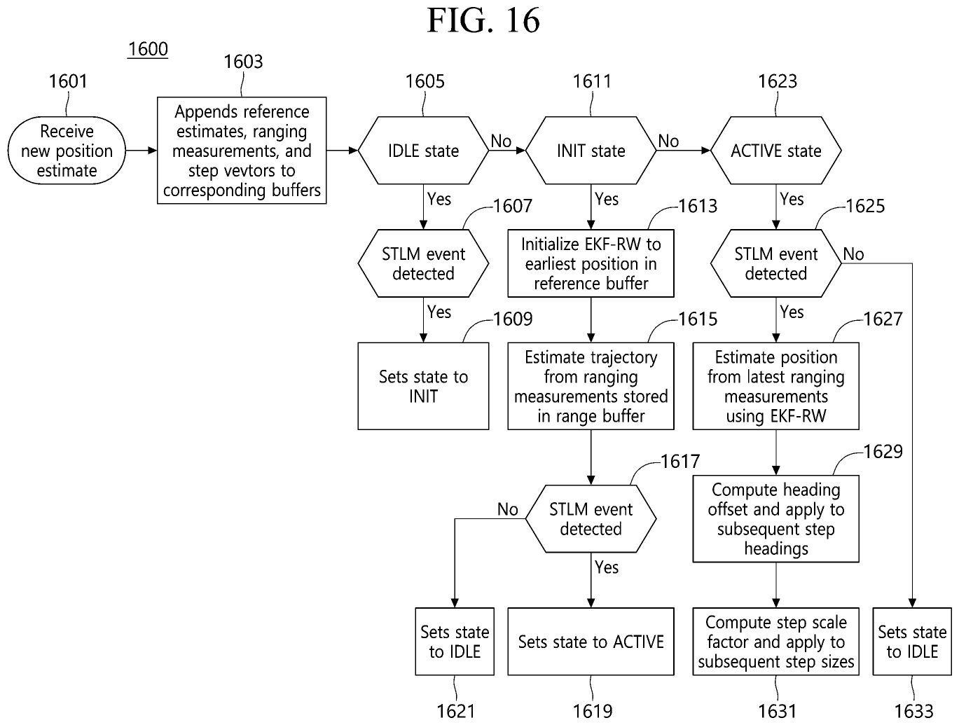

FIG. 16 shows an example flowchart of a step heading correction process 1600 in accordance with an embodiment. Although one or more operations are described or shown in particular sequential order, in other embodiments the operations may be rearranged in a different order, which may include performance of multiple operations in at least partially overlapping time periods. The flowchart depicted in FIG. 16 illustrates operations performed in the CU 830 depicted in FIG. 8A and FIG. 12 to correct the step heading after receiving a new position estimate from the positioning engine 840.

The process 1600 may begin in operation 1601. In operation 1601, the CU 830 receives new position estimates (new reference position estimates) x̅ₖ at time tₖ from the positioning engine 840. Then, the process 1600 proceeds to operation 1603.

In operation 1603, the CU 830 enqueues or appends a sequence of reference position estimates {tₖ, x̅ₖ, Pₖ} provided from the positioning engine 840 to the reference buffer 1201 and removes stale position estimates. The CU 830 enqueues or appends a sequence of ranging measurements {t″ₘ, rₘ} provided from the ranging device 820 to the range buffer 1203 and removes stale ranging measurements. Also, the CU 830 enqueues or appends a sequence of step heading information (e.g., step size and step heading) {t″ₗ, sₗ, θₗ} provided from the sensing device 810 to the step buffer 1205 and remove stale step information.

In operation 1605, the process 1600 determines if the CU 830 is in the IDLE state. When the CU 830 is in the IDLE, the process 1600 proceeds to operation 1607. Otherwise, it proceeds to operation 1611.

In operation 1607, the CU 830 determines if a straight-link motion event STLMₖ is signaled from the sensing device 810 between the two most recent epochs of position estimates between tₖ₋₁ and tₖ. If the STLMₖ is signaled, the process 1600 proceeds to operation 1609 where the CU 830 transitions to the INIT state. Otherwise, the CU 830 takes no further action until a subsequent position estimate is received.

In operation 1611, the process 1600 determines if the CU 830 is in the INIT state. When the CU 830 is in the INIT state, the process 1600 proceeds to operation 1613. Otherwise, it proceeds to operation 1623.

In operation 1613, the CU 830 initializes the damping EKF-RW 1303 at earliest time in the reference buffer 1201, as explained with reference to FIG. 13, for example.

In operation 1615, the CU 830 estimates the trajectory from ranging measurements stored in the range buffer 1203. In some embodiments, the CU 830 recursively estimates positions or trajectory {x̅ₖ}_{k>k}_{₀}, using the damping filter 1207 from the sequence of ranging measurements {rₖ}_{k>k}_{₀}.

In operation 1617, the CU 830 determines if a STLMₖ is signaled from the sensing device 810 between the two most recent epochs of position estimates between tₖ₋₁ and tₖ. If the STLMₖ is signaled, the process 1600 proceeds to operation 1619 where the CU 830 transitions to the ACTIVE state. Otherwise, the process 1600 proceeds to operation 1621 where the CU 830 transitions back to the IDLE state.

In operation 1623, the process 1600 determines if the CU 830 is in the ACTIVE state. When the CU 830 is in the ACTIVE state, the process 1600 proceeds to operation 1625.

In operation 1625, the CU 830 determines if a STLMₖ is detected from the sensing device 810 between the two most recent epochs of position estimates between tₖ₋₁ and tₖ. If the STLMₖ is detected, the process 1600 proceeds to operation 1627. Otherwise, the process 1600 proceeds to operation 1633 where the CU 830 transitions back to the IDLE state.

In operation 1627, the CU 830 estimates position from latest ranging measurements using the damping EKF-RW 1303. In some embodiments, the CU 830 estimates the positions {\hat{p}ₖ} reclusively by passing the ranging measurements {rₘ} falling between the two most recent epochs of position estimation tₖ₋₁ and tₖ through the initialized damping EKF-RW 1303, and adds the position estimates {\hat{p}ₖ} to the damped buffer 1209.

In operation 1629, the CU 830 computes step heading offset and apply the offset to subsequent step heading. In some embodiments, CU 830 computes the mean orientation ϕ̅ₖ by averaging the orientation {ϕ_{τ}} over the interval [tₖ−W, tₖ]. Then, the CU 830 computes the implied heading θ̅ₖ as the slope of straight line best fitting the position estimates {(\hat{x}_{l|l})} obtained in the interval [tₖ−W, tₖ] through a linear regression. Subsequently, the CU 830 compute the mean orientation offset as ε̅=θ̅ₖ-ϕ̅ₖ.

In operation 1631, the CU 830 computes a step scale factor and applies the factor to subsequent step size. In some embodiments, the CU 830 computes the total displacement, and scales with its subsequent step sizes as explained with reference to FIG. 10.

The embodiments outlined in this disclosure can be utilized in conjunction with positioning algorithms that use the step size and heading information as inputs. Various embodiments provided in this disclosure can be employed in diverse environments, including museums for navigating through sections of museum and reading about pieces of art in the user's vicinity, transportation terminals such as subway, train stations, and airports for navigating to gates and shops, stores for locating products, and homes for triggering smart home actions, such as turning on lights when the user enters a room.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term “include,” “have,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A method for estimating a position of a moving object, the method comprising:
storing one or more reference position estimates for the moving object in a first buffer;
storing step information in a second buffer, the step information including one or more step sizes and one or more step headings;
receiving a motion event signal indicating the moving object moves continuously with a bounded direction;
correcting the step information based on the one or more reference position estimates in response to receiving the motion event signal; and
estimating the position of the moving object using the corrected step information.

2. The method of claim 1, wherein the correcting the step information comprises:
determining a first direction based on one or more step headings stored in the second buffer;
determining a second direction based on a slope of a line derived from at least two reference position estimates stored in the first buffer;
determining an offset using the first direction and the second direction; and
correcting one or more step headings using the offset.

3. The method of claim 1, wherein the correcting the step information comprises:
determining a displacement based on a line derived from at least two reference position estimates stored in the first buffer;
determining a scale factor based on the displacement and a sum of one or more step sizes stored in the second buffer; and
correcting one or more step sizes using the scale factor.

4. The method of claim 1, further comprising:
storing one or more ranging measurements provided from a ranging device in a third buffer, the one or more ranging measurements including distances between the moving object and a set of anchor points.

5. The method of claim 4, wherein the correcting the step information comprises:
estimating positions of the moving object by filtering one or more ranging measurements stored in the third buffer using a damping filter;
determining a third direction based on one or more step headings stored in the second buffer;
determining a fourth direction based on a slope of a line derived from at least two estimated positions;
determining an offset using the third direction and the fourth direction; and
correcting one or more step headings using the offset.

6. The method of claim 5, wherein further comprising storing the estimated positions in a fourth buffer.

7. The method of claim 5, wherein the damping filter is initialized at a time which is prior to receiving the motion event signal.

8. The method of claim 1, wherein the motion event signal is received between two most recent reference position estimates.

9. The method of claim 4, wherein the step information stored in the second buffer and the one or more ranging measurements stored in the third buffer are generated between two most recent reference position estimates.

10. The method of claim 1, further comprising:
storing one or more sensor readings indicating orientation of the moving object in a fifth buffer,
wherein the correcting the step information comprises:
determining a first orientation based on one or more sensor readings in the fifth buffer;
determining a second orientation based on a slope of a line derived from at least two reference position estimates stored in the first buffer;
determining an offset using the first orientation and the second orientation; and
determining a corrected orientation using the offset.

11. A device for estimating a position of the device, comprising:
a sensor configured to generate step information, the step information including one or more step sizes and one or more step headings; and
a processor coupled to the sensor, the processor configured to cause:
storing one or more reference position estimates for the device in a first buffer;
storing the step information generated from the sensor in a second buffer;
receiving a motion event signal indicating the device moves continuously with a bounded direction from the sensor;
correcting the step information based on the one or more reference position estimates in response to receiving the motion event signal; and
estimating the position of the device using the corrected step information.

12. The device of claim 11, wherein the correcting the step information comprises:
determining a first direction based on one or more step headings stored in the second buffer;
determining a second direction based on a slope of a line derived from at least two reference position estimates stored in the first buffer;
determining an offset using the first direction and the second direction; and
correcting one or more step headings using the offset.

13. The device of claim 11, wherein the correcting the step information comprises:
determining a displacement based on a line derived from at least two reference position estimates stored in the first buffer;
determining a scale factor based on the displacement and a sum of one or more step sizes stored in the second buffer; and
correcting one or more step sizes using the scale factor.

14. The device of claim 11, further comprising:
a ranging device configured to generate one or more ranging measurements including distances between the device and a set of anchor points; and
the processor is further configured to cause:
storing the one or more ranging measurements generated from the ranging device in a third buffer.

15. The device of claim 11, wherein the correcting the step information comprises:
estimating positions of the device by filtering one or more ranging measurements stored in the third buffer using a damping filter;
determining a third direction based on one or more step headings stored in the second buffer;
determining a fourth direction based on a slope of a line derived from at least two estimated positions;
determining an offset using the third direction and the fourth direction; and
correcting one or more step headings using the offset.

16. The device of claim 15, wherein the correcting the step information further comprises storing the estimated positions in a fourth buffer.

17. The device of claim 15, wherein the damping filter is initialized at a time which is prior to receiving the motion event signal.

18. The device of claim 11, wherein the motion event signal is received between two most recent reference position estimates.

19. The device of claim 14, wherein the step information stored in the second buffer and the one or more ranging measurements stored in the third buffer are generated between two most recent reference position estimates.

20. The device of claim 11, wherein the processor is further configured to cause:
storing one or more sensor readings indicating orientation of the moving object in a fifth buffer,
wherein the correcting the step information comprises:
determining a first orientation based on one or more sensor readings in the fifth buffer;
determining a second orientation based on a slope of a line derived from at least two reference position estimates stored in the first buffer;
determining an offset using the first orientation and the second orientation; and
determining a corrected orientation using the offset.
